(19) United States
(12) Patent Application Publication
(10) Pub. No.: US 2009/0038990 A1
(43) Pub. Date: Feb. 12, 2009

(54) CATALYST USED FOR CONVERTING COAL TAR TO DIESEL OIL, ITS PREPARATION METHOD AND USE THEREOF

(75) Inventors: Gang XIAO, Beijing (CN); Xiaofeng HOU, Beijing (CN); Tao YAN, Beijing (CN); Hongxia SHI, Beijing (CN)

Correspondence Address: SCULLY SCOTT MURPHY & PRESSER, PC, 400 GARDEN CITY PLAZA, SUITE 300, GARDEN CITY, NY, 11530, US

(73) Assignee: HANERGY TECH CO., LTD., Beijing (CN)

(21) Appl. No.: 12/187,790

(22) Filed: Aug. 7, 2008

(30) Foreign Application Priority Data
Aug. 8, 2007 (CN) 200710201305.9
Aug. 29, 2007 (CN) 200710121051.X
Oct. 12, 2007 (CN) 200710202046.1

(51) Int. Cl. C10C 1/20; B01J 27/08; B01J 27/125; B01J 27/135; B01J 27/138; B01J 29/08; B01J 29/18; B01J 29/40

(52) U.S. Cl. 208/44; 502/224; 502/203; 502/231; 502/87; 502/226; 502/227; 502/79; 502/78; 502/77

(57) ABSTRACT

The present invention relates to a catalyst used for converting coal tar to diesel, the preparation method and use thereof The catalyst has a compound of iodine, an inorganic oxide matrix and the compound dispersed therein; or an inorganic oxide matrix and the compound dispersed therein together with a crystalline aluminosilicate zeolite, and relates to a method of coal tar converse to diesel in which at least one of the catalysts are used by dispersing an iodine compound in an inorganic oxide matrix.

### TECHNICAL FIELD

The present invention relates to a catalyst used for converting coal tar to diesel, in particular, relates to a catalyst containing an inorganic oxide matrix for converting coal tar to diesel. The present invention also relates to the preparation method and use thereof

### BACKGROUND

It is a research direction to utilize coal resources effectively and satisfy the requirements for the environment protection in all countries. Coal tar is one of the by products in the carbonization and gasification of coal. In China, the deep processing of coal tar attracts much attention in the 1950s and 1960s, and a lot of capital and manpower were invested into this research project. However, in the 1960s and 1970s, the research and development on the deep processing of coal tar to produce environmental-friendly liquid products with high quality almost ceased to advance due to the petroleum discovery in Daqing, Liaoning, Shandong, Henan, Xinjiang and so on. Since the late 1990s, with the increasing consumption of petroleum resources worldwide and increasing import ratio of crude oil in china, more attention was paid to how to make use of coal tar properly as a substitute for petroleum in order to obtain high quality fuel oils and other chemical raw materials.

Coal tar, as a byproduct, was produced in the coking process. There are many gasification factories that produce Gas in China, coal tar as a byproduct can also be produced in the process, In recent years, the demand for diesel oil has been increasing in the market. Although medium or low temperature, coal tar has some characteristics like natural crude oil, comparing to the natural crude oil, coal tar has greater density, higher viscosity and sulfur content, especially lower molar ratio of H/C, higher nitrogen content, and higher carbon residue and asphaltene. Therefore, the coal tar has relatively poor quality and is hard to process. With the increasing market demand for diesel oil year by year, many enterprises engaged in coal tar processing in china are searching for a method to produce diesel oil from coal tar economically.

Currently, there are about three methods to treat coal tar in China. The first method is to treat the coal tar by atmospheric or reduced pressure distillation and cut various kinds of fractions such as light oil, phenol oil, naphthalene oil, wash oil, anthracene oil and so on. The desired mono-component products such as phenol, naphthalene and anthracene are concentrated to the corresponding fractions, and further separated by chemical and physical procedures; then the high added-value products, such as naphthalene, phenol, anthracene, phenanthrene, carbazole, asphalt and so on, are obtained. This kind of procedure is complicated and requires a lot of investment, which is developing toward a direction with increasingly high technical content and large scale.

The second method is shown as follows: the coal tar is distilled at atmospheric pressure, and then the resulting fraction oils treated by acid and alkali refining are combusted directly as low quality fuel oils or combusted as fuel after emulsification. The sulfur and nitrogen impurities contained in the fuel oils turn into SO_{X} and NO_{X} in the process of combustion. In the acid and alkali refining processes, a great deal of acid residue, alkali residue and waste water are also produced. Therefore, this production method has such shortcomings as poor economic returns and environmental pollution. CN1064882A disclosed a preparation method of diesel oil by distillation and acid and alkali washing. The world is facing lots of environmental problems and the ecological environment in China is becoming worse with the development of industry On the premise of thinking highly of environment-friendly production nowadays, it is very difficult to develop this kind of production route of coal tar very well.

The third method is to produce clean fuels equivalent to a petroleum product by a proper hydrogenation refining process using coal tar as crude material. It will bring remarkable economic returns and apparent social effects. CN1464031A, CN1772846A, CN1147575C and U.S. Pat. No. 4,855,037 disclosed processes for hydrogenation and modification of coal tar and catalysts thereof. The art was generally characterized by the two-stage grading catalyst loading scheme as follows: the top part was filled with protectant and the lower part was filled with hydrogenation refining catalyst; or the three-stage grading catalyst loading scheme as follows: the top part was protectant, the middle part was hydrogenation refining catalyst and the lower part was dearomatization catalyst. The core technique was the hydrogenation catalyst.

Compared to hydrogenation of secondary processing fractions of petroleum, the key points of catalysts for hydrogenation and modification of coal tar are shown as follows: first, due to the high oxygen content in coal tar, water produced in the reaction course has an unfavorable effect on activity, hydrothermal stability and strength of the hydrogenation catalyst; second, the high contents of colloid and coal residue in the coal tar easily led to carbon deposition in the catalyst, resulted in the quick inactivation of the catalyst; third, the deep denitrification is necessary because the high content of sulfur and nitrogen in the coal tar affects the stability of diesel oil; fourth, a great deal of aromatics contained in the coal tar must be removed by deep hydrogenation. In this process, utmost saturation of aromatics is required on the premise of breaking chains as little as possible to elevate the hexadecane value of diesel oil. Compared with the catalytic hydrogenation catalyst for catalytic cracking of crude diesel oil, the catalyst for hydrogenation of coal tar is harder to achieve industrialization due to these existing problems.

Therefore, the present catalysts developed for hydrogenation of coal tar generally take porous aluminum oxide, silicon oxide, amorphous silica-alumina, titanium oxide and molecular sieve, zeolite with proper acidity as carriers, which are mixed with active components such as W, Mo, Ni, P, F, Co, etc. This kind of catalysts can efficiently eliminate the impurities such as sulfur, nitrogen, colloid, asphaltene and so on from the fractions of coal tar. However, such catalysts are expensive since they contain noble metals such as W, Mo and so on. Meanwhile, the cost is high in the hydrogenation process. Under the present circumstances such as the yearly increasing price of coal tar, the low yield of diesel oil and the cheap price of product oil, medium and small oil refineries seldom utilize this kind of catalysts because of the difficulty in investment returns.

### SUMMARY OF INVENTION

The object of the present invention is to provide a catalyst with high catalytic activity, low cost and simple process for converting coal tar to diesel oil.

Another object of the present invention is to provide a preparation method of the said catalyst.

The further object of the invention is to provide an intermittent process for converting coal tar to diesel oil with the said catalyst.

The yet another object of the invention is to provide a continuous process for converting coal tar to diesel oil with the said catalyst.

In order to accomplish the said objects, on the basis of prior art the present inventor did a lot of research and inventive work to get a catalyst used for converting coal tar to diesel oil, which comprises:
a carrier and an active ingredient, the carrier is inorganic oxide matrix, active ingredient is an iodine-containing compound, an iodine-containing compound accounted by iodine is in the amount of 0.5 to 10 parts by weight based on 100 parts by weight of catalyst, and preferably 0.8 to 3 parts by weight based on 100 parts by weight of catalyst.

Said iodine compound is soluble compound, and said iodine compound is one at least selected from the group consisting of KI, Nal, KIO₃, NaIO₃, BI₃ and mixture thereof.

The said matrix is at least one selected from the group consisting of aluminum oxide, silicon oxide, molecular sieve and mixture thereof. The said aluminum oxide is at least one selected from the group consisting of γ-Al₂O₃, η-Al₂O₃, θ-Al₂O₃, δ-Al₂O₃, χ-Al₂O₃ and mixture thereof. The said aluminum oxide is modified and the modifier is at least one elements salts selected from the group consisting of Ti, P, Mg, B, Zr, Th, Nb, rare earth and mixture thereof. Preferably, the aluminum oxide is γ-Al₂O₃ or the aluminum oxide is at least one selected from the group consisting of γ-Al₂O₃ modified with Ti, P, Mg, B, Zr, Th, Nb or rare earth. The Aluminum oxide can be purchased from the market or produced by any conventional method, for example, by calcinating at least one selected from the group consisting of alumina trihydrate, alumina monohydrate and amorphous aluminum hydroxide or a mixture thereof.

The said molecular sieve is at least one selected from the group consisting of zeolite molecular sieve and/or non-zeolite molecular sieve, such as Y type molecular sieve, β molecular sieve, mordenite zeolite, ZRP molecular sieve, ZSM-n molecular sieve, SAPO-n molecular sieve, MCM-n molecular sieve and mixture thereof. Preferably the molecular sieve is at least one selected from the group consisting of Y type molecular sieve, β molecular sieve, ZSM-5 molecular sieve, SAPO-n molecular sieve and mixture thereof. The molecular sieve can be purchased from the market or produced by any conventional method.

There is no limit to the method for dispersing the iodine compound into the said catalyst. The preferable method is shown as follows: immersing the matrix into the iodine compound solution in the range of 0.5 hours to 4 hours, then filtration and drying the matrix, obtaining the catalyst. Preferably, the said iodine compound solution is an aqueous solution. The drying process may be conventional process, preferably drying at a temperature in the range of 100° C. to 150° C., and for a time in the range of 1 hour to 12 hours, and more preferably drying at a temperature in the range of 110° C. to 130° C., and for a time in the range of 2 hours to 6 hours. No calcination procedure is necessary for the catalyst produced by said method.

The intermittent preparation process for converting coal tar to diesel oil, which comprises the following steps:

The coal tar and catalyst are put into a reactor and sealed tightly, then the temperature of the reactor is heated to the temperature of about 320° C. to 400° C., preferably 350° C. to 360° C., and holding the temperature for about 0 min to 20 min, preferably 5 min to 15 min, then the reacted products are taken out of the reactor and separated by distillation, the fractions of 80° C. to 280° C. are cut to get diesel oil. The water content of the coal tar is less than 2 wt %. The ratio of catalyst to coal tar is 0.5-4% by weight of coal tar.

The continuous preparation method of diesel oil from coal tar with said catalyst includes the following steps:

A mixture of coal tar and catalyst is continuously pumped into the preheator to dehydrate the water content at a temperature of 105° C. to 130° C., and then the mixture is pumped into the reactor to conduct the catalytic reaction for about 5 min to 60 min, the temperature of the outlet from the reactor is in the range of 320° C. to 380° C.;

the reaction products are taken out of the reactor and then separated by distillation, the fractions of 80° C. to 280° C. are cut to get diesel oil.

Preferably, the reactor is tubular furnace, and the process comprises the following steps:

A mixture of coal tar and catalyst is introduced into the first stage of the tubular furnace, the ratio of catalyst to coal tar is 0.5-4% by weight of coal tar. The reactants are heated to 105° C. to 130° C. and introduced into the evaporator of the first stage to dehydrate. The dehydrated mixture of coal tar and catalyst stays in the second stage of the tubular furnace for about 5 min to 60 min to conduct catalytic reaction, preferably stays for 10 min to 30 min. The outlet temperature of reaction products is in the range of 320° C. to 380° C.

The reaction products are taken out of the tubular furnace and then separated by distillation. The fractions of 80° C. to 280° C. are cut to get diesel oil. The water content of said coal tar is less than 2 wt %.

The tubular furnace of the present invention is conventional industrial equipment. The structural schematic and related description of the tubular furnace can be seen in “Separation and Refinement of Coal Tar” (Shui Hengif, Zhang Dexiang, Zhang Chaoqun, etc., Chemical Industry Publishing House. 2007: page 53-59).

No hydrogenation and modification of coal tar are needed in the process for converting coal tar to diesel oil with the catalyst according to the present invention, and the process is simple, the related technology can be grasped easily, and the equipments is low cost. Comparing to the conventional method for converting coal tar to diesel oil, the productivity of the present invention is much higher, and the crude diesel oil prepared with said catalyst can be preserved for a long time without darkening in color. Also, because of the decrease of the high boiling fractions in the oil products, it is easy to conduct further lo processing of the crude diesel oil. The experiments show that the productivity of diesel oil are all over 64% when converting coal tar to diesel oil with the catalyst according to the present invention.

Moreover, when the catalyst according to the present invention is used to continuously produce diesel oil from coal tar, the tubular furnace may be used as reactor The coal tar as raw material oil and the catalyst can be continuously introduced into the tubular furnace, then water and light oils are removed in the evaporator of the first stage, and catalytic reaction is conducted at the second stage of the tubular furnace. The reaction products are isolated by distillation after exported from the tubular furnace. The fractions of 80-280° C. are cut to get diesel oil. The present invention is applicable for industrialization due to its continuous mode of preparation.

### EMBODIMENT

The present invention is further illustrated with reference to the following examples.

The physical properties of coal tar used as raw material in examples 1 to 14 are as follows:

Density: 1005 kg/M³;

Content of coal residue: 1.2 wt %;

Freezing point: 27° C.;

Initial boiling point and 10% boiling point in the distillation range (IBP/10%): 150° C./240° C.;

50% and 90% boiling point in the distillation range: 325° C./410° C.;

Final boiling point (FBP): 512° C.

The modified alumina and molecular sieves used below are all purchased from the market.

### EXAMPLE 1

Catalyst components: Y type molecular sieve: 50 g; water solution containing 0.8 g of potassium iodide: 30 ml;

preparation method: Y type molecular sieve (produced by Rongdeli Molecular Sieve Factory in Wuxi) was immersed in the potassium iodide water solution for 2 hours, ten dried at 120° C. for 2 hours to get the catalyst. The properties of the catalyst were shown in Table 1.

Potassium iodide occupied 1.21 percent of the catalyst weight (calculated by iodine).

The intermittent preparation method of diesel oil from coal tar with said catalyst includes:

300 g of coal tar with water content of 1 wt % was put into a 1000 ml high pressure reactor, and then 4.5 g of catalyst was added. After being closed tightly, the reactor was heated to 350° C. and kept at this temperature for 5 minutes. Upon cooling to ambient temperature, the reaction products were taken out of the reactor and separated by distillation. The fractions obtained in the range of 80° C. to 280° C. are diesel oil. The amount of the catalyst was 1.5 percent relative to the weight of coal tar. The properties of the diesel oil were shown in Table 2.

The continuous preparation method of diesel oil from coal tar with said catalyst includes:

The coal tar with a water content of 1 wt % was mixed with said catalyst. The mixture was pumped into the first stage of tubular furnace by a feed stock pump and heated to 120° C. to 130° C., and then sent to dehydrate in the evaporator of the first stage. The dehydrated mixture of catalyst and coal tar stayed at the second stage of the tubular furnace for 15 minutes to conduct catalytic reaction. The outlet temperature of reaction products was kept at about 350° C. to 355° C. The reaction products were separated by distillation after exported from the tubular furnace, and the fractions obtained from the range of 80° C. to 280° C. were diesel oil. The amount of said catalyst was 1.5 percent relative to the weight of coal tar. The properties of the diesel oil were shown in Table 3.

### EXAMPLE 2

Catalyst components: ZSM-5 molecular sieve: 50 g; water solution containing 0.8 g of potassium iodide: 25 ml;

Preparation method: The ZSM-5 molecular sieve (produced by Zibo Zichuan Phoenix Fine Chemicals Co., Ltd.) was immersed in the potassium iodide water solution for 2 hours, then dried at 120° C. for 2 hours to get the catalyst. The properties of the catalyst were shown in Table 1.

Potassium iodide occupied 1.21 percent of the catalyst weight (calculated by iodine).

The intermittent preparation method of diesel oil from coal tar with said catalyst includes:

300 g of coal tar with a water content of 0.1 wt % was put into a 1000 ml high pressure reactor, and then 4.5 g of catalyst was put therein. After being closed tightly, the reactor was heated to 360° C. and kept at this temperature for 10 minutes. Upon cooling to ambient temperature, the reaction products were taken out of the reactor and separated by distillation. The fractions obtained in the range of 80° C. to 280° C. are diesel oil. The amount of the catalyst was 1.5 percent relative to the weight of coal tar. The properties of the diesel oil were shown in Table 2.

The continuous preparation method of diesel oil from coal tar with said catalyst includes:

The coal tar with a water content of 0.1 wt % was mixed with said catalyst. The mixture was pumped into the first stage of tubular furnace by a feed stock pump, heated to 105° C. to 115° C., and then sent to dehydrate in the evaporator of the first stage. The dehydrated mixture of catalyst and coal tar stayed at the second stage of the tubular furnace for 60 minutes to conduct catalytic reaction. The outlet temperature of reaction products was kept at about 320° C. to 330° C. The reaction products were separated by distillation after exported from the tubular furnace and the fractions obtained from the range of 80° C. to 280° C. were diesel oil. The amount of said catalyst was 1.5 percent relative to the weight of coal tar. The properties of the diesel oil were shown in Table 3.

### EXAMPLE 3

Catalyst components: γ-Al₂O₃: 50 g; water solution containing 1.0 g of potassium iodide: 30 ml;

Preparation method: The γ-Al₂O₃ molecular sieve was immersed in the potassium iodide water solution for 2 hours, then dried at 120° C. for 1 hour to get the catalyst. The properties of the catalyst were shown in Table 1.

Potassium iodide occupied 1.66 percent of the catalyst weight (calculated by iodine).

The intermittent preparation method of diesel oil from coal tar with said catalyst includes:

300 g of coal tar with a water content of 1.8 wt % was put into a 1000 ml high pressure reactor, and then 4.5 g of catalyst was put into therein. After being closed tightly, the reactor was heated to 350° C. and kept at this temperature for 15 minutes. Upon cooling to room temperature, the reaction product were taken out of the reactor and separated by distillation. The fractions from the range of 80° C. to 280° C. were cut to get the diesel oil. The amount of the catalyst was 1.5 percent relative to the weight of coal tar. The properties of the diesel oil were shown in Table 2.

The continuous preparation method of diesel oil from coal tar with said catalyst includes:

The coal tar with a water content of 1.8 wt % was mixed with said catalyst. The mixture was pumped into the first stage of tubular furnace by a feed stock pump, heated to 110° C. to 120° C., and then sent to dehydrate in the evaporator of the first stage. The dehydrated mixture of catalyst and coal tar stayed at the second stage of the tubular furnace for 5 minutes to conduct catalytic reaction. The outlet temperature of reaction products was kept at about 360° C. to 380° C. The reaction products were exported from the tubular furnace and then separated by distillation. The fractions obtained in the range of 80° C. to 280° C. were diesel oil. The amount of said catalyst was 1.5 percent relative to the weight of coal tar. The properties of the diesel oil were shown in Table 3.

### EXAMPLE 4

Catalyst components: Ti-modified γ-Al₂O₃: 50 g; water solution containing 0.3 g of sodium iodide: 30 ml;

Preparation method: The Ti-modified γ-Al₂O₃ (produced by Wenzhou Alumina Plant) was immersed in the sodium iodide water is solution for 0.5 hours, then dried at 110° C. for 3 hours to give the catalyst. The properties of the catalyst were shown in Table 1.

Sodium iodide occupied 0.5 percent of the catalyst weight (calculated by iodine).

The intermittent preparation method of diesel oil from coal tar with said catalyst includes:

300 g of coal tar with a water content of 2.0 wt % was put into a 1000 ml high pressure reactor, and then 1.5 g of catalyst was put into therein. After being closed tightly, the reactor was heated to 365° C. and kept at this temperature for 1 minute. Upon cooling to ambient temperature, the reaction product were taken out of the reactor and separated by distillation. The fractions from the range of 80° C. to 280° C. are cut to get the diesel oil. The amount of the catalyst was 0.5 percent relative to the weight of coal tar. The properties of the diesel oil were shown in Table 2.

The continuous preparation method of diesel oil from coal tar with said catalyst includes:

The coal tar containing with a water content of 2.0 wt % was mixed with said catalyst. The mixture was pumped into the first stage of tubular furnace by a feed stock pump, heated to 115° C. to 120° C., and then sent to dehydrate in the evaporator of the first stage. The dehydrated mixture of catalyst and coal tar stayed at the second stage of is the tubular furnace for 10 minutes to conduct catalytic reaction. The outlet temperature of reaction products was kept at about 360° C. to 370° C. The reaction products were exported from the tubular furnace and then separated by distillation. The fractions obtained from the range of 80° C. to 280° C. were diesel oil. The amount of said catalyst was 0.5 percent relative to the weight of coal tar. The properties of the diesel oil were shown in Table 3.

### EXAMPLE 5

Catalyst components: Mg-modified η-Al₂O₃: 35 g; β zealite: 15 g; water solution containing 0.68 g of potassium iodate: 30 ml;

preparation method: The Mg-modifiedη-Al₂O₃ (produced by Wenzhou Alumina Plant) and the β zealite were immersed in the potassium iodate water solution for 3 hours, then dried at 130° C. for 1.5 hours to give the catalyst. The properties of the catalyst were shown in Table 1.

Potassium iodate occupied 0.8 percent of the catalyst weight (accounting by iodine).

The intermittent preparation method of diesel oil from coal tar with said catalyst including:

300 g of coal tar with a water content of 1.4 wt % was put into a 1000 ml high pressure reactor, and then 12 g of catalyst was put into is therein. After being closed tightly, the reactor was heated to 320° C. and kept at the temperature for 8 minutes. Upon cooling to room temperature, the reaction product were taken out of the reactor and separated by distillation. The fractions in the range of 80° C. to 280° C. were cut to get the diesel oil. The amount of the catalyst was 4 percent relative to the weight of coal tar. The properties of the diesel oil were shown in Table 2.

The continuous preparation method of diesel oil from coal tar with said catalyst includes:

The coal tar with a water content of 1.4 wt % was mixed with said catalyst. The mixture was pumped into the first stage of tubular furnace by a feed stock pump and heated to 120° C. to 125° C., and then sent to dehydrate in the evaporator of the first stage. The dehydrated mixture of catalyst and coal tar stayed at the second stage of the tubular furnace for 20 minutes to conduct catalytic reaction. The outlet temperature of reaction products was kept at about 350° C. to 360° C. The reaction lo products were exported from the tubular furnace, and then separated by distillation. The fractions obtained from the range of 80° C. to 280° C. were diesel oil. The amount of said catalyst was 4 percent relative to the weight of coal tar. The properties of the diesel oil were shown in Table 3.

### EXAMPLE 6

Catalyst components: P-modified θ-Al₂O₃: 25 g; mordenite zeolite: 25 g; water solution containing 1.61 g sodium iodate: 30 ml;

Preparation method: The P-modified θ-Al₂O₃ (produced by Wenzhou Alumina Plant) and mordenite zeolite were immersed in the sodium iodate water solution for 4 hours, then dried at 110° C. for 12 hours to get the catalyst. The properties of the catalyst were shown in Table 1.

Sodium iodate occupied 2 percent of the catalyst weight (accounting by iodine).

The intermittent preparation method of diesel oil from coal tar with said catalyst includes:

300 g of coal tar with a water content of 0.5 wt % was put into a 1000 ml high pressure reactor, and then 9.0 g of catalyst was put into therein. After being closed tightly, the reactor was heated to 400° C. and then cooled to ambient temperature. The reaction products were taken out of the reactor and separated by distillation. The fractions in the range of 80° C. to 280° C. were cut to get the diesel oil. The amount of the catalyst was 3 percent relative to the weight of coal tar. The properties of the diesel oil were shown in Table 2.

The continuous preparation method of diesel oil from coal tar with said catalyst including:

The coal tar with a water content of 0.5 wt % was mixed with said catalyst. The mixture was pumped into the first stage of tubular furnace by a feed stock pump, heated to 125° C. to 130° C., and then sent to dehydrate in the evaporator of the first stage. The dehydrated mixture of catalyst and coal tar stayed at the second stage of the tubular furnace for 30 minutes to conduct catalytic reaction. The outlet temperature of reaction products was kept at about 330° C. to 340° C. The reaction products were exported from the tubular furnace, and then separated by distillation. The fractions obtained in the range of 80° C. to 280° C. were diesel oil. The amount of said catalyst was 3 percent relative to the weight of coal tar. The properties of the diesel oil were shown in Table 3.

### EXAMPLE 7

Catalyst components: Th-modified δ-Al₂O₃: 10 g; MCM-41 molecular sieve: 40 g; water solution containing 1.59 g of boron iodide: 30 ml;

Preparation method: Th-modified δ-Al₂O₃ (sold by Jinghua 1o Engineering Ceramic Materials Company, Ltd. of Jiyuan) and MCM-41 molecular sieve were immersed into the boron iodide water solution for 2.5 hours, then dried at 125° C. for 10 hours to get the catalyst. The properties of the catalyst were shown in Table 1.

Boron iodide occupied 3 percent of the catalyst weight (calculated by iodine).

The intermittent preparation method of diesel oil from coal tar with said catalyst includes:

300 g of coal tar with a water content of 1.6 wt % was put into a 1000 ml high pressure reactor, and then 3.0 g of catalyst was put into therein. After being closed tightly, the reactor was heated to 330° C., kept at this temperature for 20 minutes, then cooled to ambient temperature. The reaction products were taken out of the reactor and separated by distillation. The fractions from the range of 80° C. to 280° C. were cut to get the diesel oil The amount of the catalyst was 1 percent relative to the weight of coal tar. The properties of the diesel oil were shown in Table 2.

The continuous preparation method of diesel oil from coal tar with said catalyst includes:

The coal tar with a water content of 1.6 wt % was mixed with said catalyst. The mixture was pumped into the first stage of tubular furnace by a feed stock pump, heated to 120° C. to 130° C., and then sent to dehydrate in the evaporator of the first stage. The dehydrated mixture of catalyst and coal tar stayed at the second stage of the tubular furnace for 40 minutes to conduct catalytic reaction. The outlet temperature of reaction products was kept at about 345° C. to 355° C. The reaction products were exported from the tubular furnace, and then separated by distillation. The fractions obtained from the range of 80° C. to 280° C. were diesel oil. The amount of said catalyst was 1 percent relative to the weight of coal tar. The properties of the diesel oil were shown in Table 3.

### EXAMPLE 8

Catalyst components: Zr-modified χ-Al₂O₃: 20 g; SAPO-5 molecular sieve: 30 g; water solution containing 3.32 g of sodium iodate: 30 ml;

Preparation method: The Zr-modified χ-Al₂O₃ (sold by Jinghua Engineering Ceramic Materials Company, Ltd. of Jiyuan) and the SAPO-5 molecular sieve were immersed in the sodium iodate water solution for 3.5 hours, then dried at 115° C. for 8 hours to get the catalyst. The properties of the catalyst were shown in Table 1.

Sodium iodate occupied 4 percent of the catalyst weight (calculated by iodine).

The intermittent preparation method of diesel oil from coal tar with said catalyst includes:

300 g of coal tar with a water content of 0.7 wt % was put into a 1000 ml high pressure reactor, and then 10 g of catalyst was put into therein. After being closed tightly, the reactor was heated to 380° C. and kept at this temperature for 18 minutes, then cooled to ambient temperature. The reaction products were taken out of the reactor and separated by distillation. The fractions from the range of 80° C. to 280° C. were cut to get the diesel oil. The amount of the catalyst was 3.3 percent relative to the weight of coal tar. The properties of the diesel oil were shown in Table 2.

The continuous preparation method of diesel oil from coal tar with said catalyst includes.

The coal tar with a water content of 0.7 wt % was mixed with said catalyst. The mixture was pumped into the first stage of tubular furnace by a feed stock pump, heated to 110° C. to 125° C., and then sent to dehydrate in the evaporator of the first stage. The dehydrated mixture of catalyst and coal tar stayed at the second stage of the tubular furnace for 50 minutes to conduct catalytic reaction. The outlet temperature of reaction products was kept at about 340° C. to 345° C. The reaction products were exported from the tubular furnace and then separated by distillation. The fractions obtained from the range of 80° C. to 280° C. were diesel oil. The amount of said catalyst was 3.3 percent relative to the weight of coal tar. The properties of the diesel oil were shown in Table 3.

### EXAMPLE 9

Catalyst components: Nb-modified γ-Al₂O₃: 30 g; ZRP molecular sieve: 20 g; water solution containing 2.71 g of boron iodide: 30 ml;

Preparation method: The Nb-modified γ-Al₂O₃ (sold by Jinghua Engineering Ceramic Materials Company, Ltd. of Jiyuan) and the ZRP molecular sieve were immersed in the boron iodide water solution for 1.5 hours and then dried at 113° C. for 6 hours to give the catalyst. The properties of the catalyst were shown in Table 1.

Boron iodide occupied 5 percent of the catalyst weight (calculated by iodine).

The intermittent preparation method of diesel oil from coal tar with said catalyst includes:

300 g of coal tar with a water content of 1.2 wt % was put into a 1000 ml high pressure reactor, and then 6 g of catalyst was put therein. After being closed tightly, the reactor was heated to 340° C. and kept at this temperature for 13 minutes, then cooled to ambient temperature. The reaction products were taken out of the reactor and separated by distillation. The fractions from the range of 80° C. to 280° C. were cut to get diesel oil. The amount of the catalyst was 2 percent relative to the weight of coal tar. The properties of the diesel oil were shown in Table 2.

The continuous preparation method of diesel oil from coal tar with said catalyst including:

The coal tar with a water content of 2.0 wt % was mixed with said catalyst. The mixture was pumped into the first stage of tubular furnace by a feed stock pump, heated to 120° C. to 130° C., and then sent to dehydrate in the evaporator of the first stage. The dehydrated mixture of catalyst and coal tar stayed at the second stage of the tubular furnace for 18 minutes to conduct catalytic reaction. The outlet temperature of reaction products was kept at about 350° C. to 360° C. The reaction products were exported from the tubular furnace and were separated by distillation. The fractions obtained from the range of 80° C. to 280° C. were diesel oil. The amount of said catalyst was 2 percent relative to the weight of coal tar. The properties of the diesel oil were shown in Table 3.

### EXAMPLE 10

Catalyst components: γ-Al₂O₃ modified with rare earth: 50 g; water solution containing 5.63 g of potassium iodate: 30 ml;

The preparation method of the catalyst and the method of producing diesel oil from coal tar with said catalyst were the same as those described in Example 1, wherein γ-Al₂O₃ modified with rare earth was purchased from Jinghua Engineering Ceramic Materials Company, Ltd. of Jiyuan.

The amount of potassium iodate in the catalysts used in example 10 was 6 percent relative to the weight of the catalyst (calculated by iodine).

### EXAMPLE 11

Catalyst components: γ-Al₂O₃ modified with Mg, Ti: 50 g; water is solution containing 6.13 g of sodium iodate: 30 ml;

The preparation method of the catalyst and the method of producing diesel oil from coal tar with the catalyst were the same as those described in Example 2, wherein the γ-Al₂O₃ modified with Mg, Ti was purchased from Jinghua Engineering Ceramic Materials Company, Ltd. of Jiyuan.

The amount of sodium iodate in the catalysts applied in example 11 was 7 percent relative to the weight of the catalyst (calculated by iodine).

### EXAMPLE 12

Catalyst components: Zr-modified γ-Al₂O₃: 20 g; Ti-modified χ-Al₂O₃: 30 g; Water solution containing 5.84 g of sodium iodide: 30 ml;

The preparation method of the catalyst and the method of producing diesel oil from coal tar with the catalyst were the same as those described in Example 4, wherein the Zr-modified γ-Al₂O₃ was purchased from Jinghua Engineering Ceramic Materials Company, Ltd. of Jiyuan.

The amount of sodium iodide in the catalysts applied in example 12 was 8 percent relative to the weight of the catalyst (calculated by iodine).

### EXAMPLE 13

Catalyst components: Th-modified γ-Al₂O₃: 15 g; Nb-modified θ-Al₂O₃: 15 g; Y type molecular sieve: 20 g; Water solution containing 8.44 g of potassium iodate: 30 ml;

The preparation method of the catalyst and the method of producing diesel oil from coal tar with the catalyst were the same as those described in Example 3, wherein the Th-modified γ-Al₂O₃ and the Nb-modified γ-Al₂O₃ were purchased from Jinghua Engineering Ceramic Materials Company, Ltd. of Jiyuan.

The amount of potassium iodate in the catalysts applied in example 13 was 9 percent relative to the weight of the catalyst (calculated by iodine).

### EXAMPLE 14

Catalyst components: η-Al₂O₃ modified with rare earth: 25 g; Ti-modified δ-Al₂O₃: 15 g; ZSM-5 molecular sieve: 10 g; water solution containing 7.52 g of potassium iodide: 30 ml;

The preparation method of the catalyst and the method of producing diesel oil from coal tar with the catalyst were the same as those described in Example 5, wherein γ-Al₂O₃ modified with rare earth and the Ti-modified δ-Al₂O₃ were purchased from Jinghua Engineering Ceramic Materials Company, Ltd. of Jiyuan.

The amount of potassium iodide in the catalysts applied in example 14 was 10 percent relative to the weight of the catalyst (calculated by iodine).

All the catalysts produced in example 1-14 were spherical particles.

TABLE 1
Main physical and chemical properties of the catalyst

| | | | | | | | | | | Exam- | Exam- | Exam- | Exam- | Exam- |
|---|---|---|---|---|---|---|---|---|---|---|---|---|---|---|
| | | | | Exam- | Exam- | Exam- | Exam- | Exam- | Exam- | ple | ple | ple | ple | ple |
| | Example 1 | Example 2 | Example 3 | ple 4 | ple 5 | ple 6 | ple 7 | ple 8 | ple 9 | 10 | 11 | 12 | 13 | 14 |
| Specific | 700 | 400 | 300 | 280 | 387 | 356 | 458 | 295 | 400 | 458 | 300 | 410 | 360 | 290 |
| surface | | | | | | | | | | | | | | |
| m²/g | | | | | | | | | | | | | | |

TABLE 2
Properties of diesel oil

| | | | | | | | | | | Exam- | Exam- | Exam- | Exam- | Exam- |
|---|---|---|---|---|---|---|---|---|---|---|---|---|---|---|
| | Exam- | Exam- | Exam- | Exam- | Exam- | Exam- | Exam- | Exam- | Exam- | ple | ple | ple | ple | ple |
| | ple 1 | ple 2 | ple 3 | ple 4 | ple 5 | ple 6 | ple 7 | ple 8 | ple 9 | 10 | 11 | 12 | 13 | 14 |
| Density | 0.95 | 0.94 | 0.95 | 0.95 | 0.95 | 0.95 | 0.96 | 0.95 | 0.95 | 0.95 | 0.95 | 0.95 | 0.95 | 0.95 |
| (kg/m³) | | | | | | | | | | | | | | |
| Carbon residue | 0.3 | 0.2 | 0.3 | 0.3 | 0.3 | 0.34 | 0.4 | 0.3 | 0.3 | 0.28 | 0.35 | 0.29 | 0.34 | 0.28 |
| (wt %) | | | | | | | | | | | | | | |
| Freezing point | −5 | −6 | −5 | −5 | −5 | −4 | −5 | −5 | −5 | −6 | −4 | −6 | −5 | −5 |
| (° C.) | | | | | | | | | | | | | | |
| IBP/10% | 110/200 | 110/180 | 120/190 | 115/200 | 110/195 | 115/195 | 117/195 | 120/195 | 115/200 | 130/195 | 115/195 | 115/195 | 120/195 | 130/195 |
| 50%/90% | 280/350 | 240/340 | 290/345 | 275/330 | 280/340 | 270/340 | 280/350 | 280/340 | 280/350 | 280/340 | 280/350 | 280/350 | 280/340 | 290/340 |
| FBP | 380 | 375 | 392 | 395 | 385 | 390 | 385 | 380 | 385 | 390 | 390 | 390 | 395 | 390 |
| Yield of crude | 68 | 69 | 65 | 70 | 69 | 68 | 65 | 66 | 66 | 64 | 65 | 67 | 68 | 66 |
| diesel oil (%) | | | | | | | | | | | | | | |

TABLE 3
Properties of coal tar and diesel oil

| | | | | | | | | | | Exam- | Exam- | Exam- | Exam- | Exam- |
|---|---|---|---|---|---|---|---|---|---|---|---|---|---|---|
| | Exam- | Exam- | Exam- | Exam- | Exam- | Exam- | Exam- | Exam- | Exam- | ple | ple | ple | ple | ple |
| | ple 1 | ple 2 | ple 3 | ple 4 | ple 5 | ple 6 | ple 7 | ple 8 | ple 9 | 10 | 11 | 12 | 13 | 14 |
| Density | 0.92 | 0.93 | 0.93 | 0.94 | 0.92 | 0.92 | 0.93 | 0.92 | 0.92 | 0.92 | 0.92 | 0.92 | 0.92 | 0.93 |
| (kg/m³) | | | | | | | | | | | | | | |
| Carbon residue | 0.3 | 0.2 | 0.3 | 0.3 | 0.3 | 0.34 | 0.4 | 0.3 | 0.3 | 0.28 | 0.35 | 0.29 | 0.34 | 0.28 |
| (wt %) | | | | | | | | | | | | | | |
| Freezing point | −15 | −16 | −15 | −15 | −15 | −14 | −15 | −15 | −15 | −16 | −14 | −16 | −15 | −15 |
| (° C.) | | | | | | | | | | | | | | |
| IBP/10% | 110/200 | 110/180 | 120/190 | 115/200 | 110/195 | 115/195 | 117/195 | 120/195 | 115/200 | 130/195 | 115/195 | 115/195 | 120/195 | 130/195 |
| 50%/90% | 280/320 | 240/320 | 290/325 | 275/310 | 280/310 | 270/310 | 280/320 | 280/310 | 280/325 | 280/315 | 280/317 | 280/320 | 280/310 | 290/320 |
| FBP | 330 | 335 | 332 | 335 | 335 | 333 | 335 | 330 | 335 | 330 | 330 | 330 | 325 | 320 |
| Yield of diesel | 60 | 60 | 60 | 59 | 59 | 60 | 60 | 60 | 60 | 60 | 61 | 60 | 60 | 60 |
| oil (%) | | | | | | | | | | | | | | |

1. A catalyst used for converting coal tar to diesel oil, the catalyst comprises a carrier and an active ingredient, wherein the carrier is inorganic oxide matrix, Wherein active ingredient is an iodine-containing compound, an iodine-containing compound accounted by iodine is in the amount of 0.5 to 10 parts by weight based on 100 parts by weight of catalyst.

2. The catalyst for converting coal tar to diesel oil according to claim 1, wherein the said iodine-containing compound accounting by iodine is in the amount of 0.8 to 3 parts by weight based on 100 parts by weight of catalyst.

3. The catalyst for converting coal tar to diesel oil according to claim 1 or 2, wherein said iodine-containing compound is soluble compound.

4. The catalyst for converting coal tar to diesel oil according to claim 1 or 3, wherein said iodine compound is one at least selected from the group consisting of KI, NaI, KIO₃, NaIO₃ and BI₃, and mixture thereof.

5. The catalyst for converting coal tar to diesel oil according to claim 1, wherein said matrix is one at least selected from the group consisting of aluminum oxide, silicon oxide, molecular sieve, and mixture thereof.

6. The catalyst for converting coal tar to diesel oil according to claim 5, wherein said aluminum oxide is one at least selected from the group consisting of γ-Al₂O₃, η-Al₂O₃, θ-Al₂O₃, δ-Al₂O₃ and χ-Al₂O₃.

7. The catalyst for converting coal tar to diesel oil according to claim 6, wherein said aluminum oxide is modified and the modifier is at least one element salts selected from the group consisting of Ti, P, Mg, B, Zr, Th, Nb and rare earth element, and mixtures thereof.

8. The catalyst for converting coal tar to diesel oil according to claims 5, 6, or 7, wherein said molecular sieve is at least one selected from the group consisting of Y type molecular sieve, β type molecular sieve, mordenite zeolite, ZRP molecular sieve, ZSM-n molecular sieve, SAPO-n molecular sieve and MCM-n molecular sieve, and mixtures thereof.

9. The preparation method of catalyst for converting coal tar to diesel oil according to claim 1, wherein said preparation method is shown as fellows: immersing the matrix into the iodine-containing compound solution in the range of 0.5 hours to 4 hours, then filtration and drying the matrix, obtaining the catalyst.

10. The preparation method of catalyst for converting coal tar to diesel oil according to claim 9, wherein said iodine-containing compound solution is an aqueous solution.

11. The preparation method of catalyst for converting coal tar to diesel oil according to claim 9, wherein the drying process take place at a temperature in the range of about 100° C. to 150° C., and the time in the range of about 1 hour to 12 hours.

12. The preparation method of catalyst for converting coal tar to diesel oil according to claim 11, wherein said drying process take place at a temperature in the range of about 110° C. to 130° C., and the time in the range of about 2 hours to 6 hours.

13. The process for producing diesel oil from coal tar with the said catalyst according to claim 1, wherein the process is as follows:
The coal tar and catalyst are put into the reactor and sealed tightly, then the temperature of reactor is heated to the range of 320° C. to 400° C., holding it at the temperature for 0 minute to 20 minutes, the reacted products are taken out of the reactor and separated by distillation, the fractions of 80° C. to 280° C. are cut to get diesel oil;
or A mixture of coal tar and catalyst is continuously pumped into the preheator to dehydrate the water content, the temperature is in the range of 105° C. to 130° C.; then the mixture pumped into the reactor to conduct catalytic reaction for 5-60minutes, the temperature of outlet from reactor is in the range of 320° C. to 380° C. The reaction products are taken out of the reactor and then separated by distillation, the fractions of 80° C. to 280° C. are cut to get diesel oil.

14. The process for producing diesel oil from coal tar according to claim 13, wherein the temperature of reactor is heated to 350° C. to 360° C., and holding it at the temperature for 5 minutes to 15 minutes.

15. The process for producing diesel oil from coal tar according to claim 13 or 14, wherein the water content of coal tar is less than 2 wt %.

16. The process for producing diesel oil from coal tar according to claim 13 or 14, wherein the ratio of catalyst to coal tar is about 0.5 to 4 parts by weight of coal tar.
